(19) United States
(12) Patent Application Publication
(10) Pub. No.: US 2006/0064711 A1
(43) Pub. Date: Mar. 23, 2006

(54) Recording and reproducing apparatus provided with a shock-absorbing member

(75) Inventor: Yuan-Hung Chang, Taipei (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/050,940

(22) Filed: Feb. 7, 2005

(30) Foreign Application Priority Data
Sep. 17, 2004 (TW) 93128319

(51) Int. Cl. G11B 5/027; G11B 33/08; G11B 33/14

(52) U.S. Cl. 720/651

(57) ABSTRACT

A recording and reproducing apparatus includes an outer casing defining a base member, a chassis disposed above the base member for holding a plurality of electronic elements thereon, and a shock-absorbing member disposed between the base member and the chassis. The shock-absorbing member has a main body and two extended portion for absorbing horizontal and vertical impacts.

### FIELD OF THE INVENTION

The invention relates to an optical recording and reproducing apparatus, more particularly to the recording and reproducing apparatus provided with a shock-absorbing member to absorb a horizontal impact in addition to a vertical impact.

### BACKGROUND OF THE INVENTION

The optical disks are becoming more and more important in the information field for backing up data and exchanging information due to its many advantages including a high storage capacity, easy to handle and carry, and a long preserving time for the stored data. The disks are used since data can be easily recorded and reproduced. Thus, the optical recording and reproducing apparatus can be found all around us, such as in desktop computers, laptop computers, VCD or DVD players. The recording and reproducing apparatus is sometimes simply called as a disk drive. In this case, the recording and reproducing apparatus is installed within a movable article, such as an automobile or a carry-along notebook computer, vibration resulting from movement of the vehicle or the notebook computer should be taken into consideration seriously since the vibration can lower or cause damage to the recording/reproducing ability of the apparatus.

Referring to FIG. 1, a sectional view of a conventional optical recording and reproducing apparatus is shown. The recording and reproducing apparatus includes an outer casing defining a lower base member 5, a chassis 2 disposed above the lower base member 5 for carrying a plurality of electronic components, such as a pick-up head for reading an inserted disk, and a shock-absorbing member 4. In this case, the aforesaid conventional recording and reproducing apparatus is installed in the automobile, the shock-absorbing member 4 includes a plurality of extension springs 402 disposed between the chassis 2 and the lower base member 5 to absorb the vibration resulting from movement of the automobile so as to provide stable reading operation of the pick-up head. It is noted that the extension springs 402 installed within the conventional recording and reproducing apparatus of FIG. 1 can only absorb the vibration in the D1 direction (vertical direction).

Referring to FIG. 2, a sectional view of another conventional recording and reproducing apparatus is shown. The recording and reproducing apparatus has the structure similar to the previous one. The only difference resides in that in order to absorb the vibration caused due to a horizontal impact, the shock-absorbing member 4 further includes a plurality of extension springs 404 that are mounted between the upper base member 6 of the outer casing and the chassis 2 in an inclination state and that can absorb the vibration in the D2 direction (horizontal direction). However, mounting of the extension springs 402, 404 at different positions and at different inclination is laborious to the manufacture and requires extra time.

### SUMMARY OF THE INVENTION

The object of the present invention is to provide a recording and reproducing apparatus which includes a shock-absorbing member of simple structure that can absorb the vibration in the horizontal direction and the vertical direction.

The recording and reproducing apparatus according to the present invention includes: an outer casing defining a base member, a chassis disposed above the base member for holding a plurality of electronic elements thereon, and a shock-absorbing member disposed between the base member and the chassis. The shock-absorbing member has a main body and two extended portions. The main body has a shape like a coil spring and defines a tension direction. The extended portions extend along the tension direction from two opposite sides of the main body respectively. One of the extended portions is mounted on the base member and the other is fastened to the chassis so as to absorb vibration caused when horizontal and vertical pressures are applied onto the chassis.

### BRIEF DESCRIPTION OF THE DRAWING

Other features and advantages of this invention will become more apparent in the following detailed description of the preferred embodiments of this invention, with reference to the accompanying drawings, in which:

FIG. 1 is a sectional view of a conventional recording and reproducing apparatus;

FIG. 2 is a sectional view of another conventional recording and reproducing apparatus;

FIG. 3 is an exploded view of the preferred embodiment of a recording and reproducing apparatus of the present with an outer casing removed therefrom;

FIG. 4 is a perspective view of the preferred embodiment shown in FIG. 3, illustrating how a shock-absorbing member supports a chassis thereon;

FIG. 5A shows a perspective view a shock-absorbing member of the preferred embodiment in a normal state; and

FIG. 5B shows the shock-absorbing member of the preferred embodiment in a compressed state.

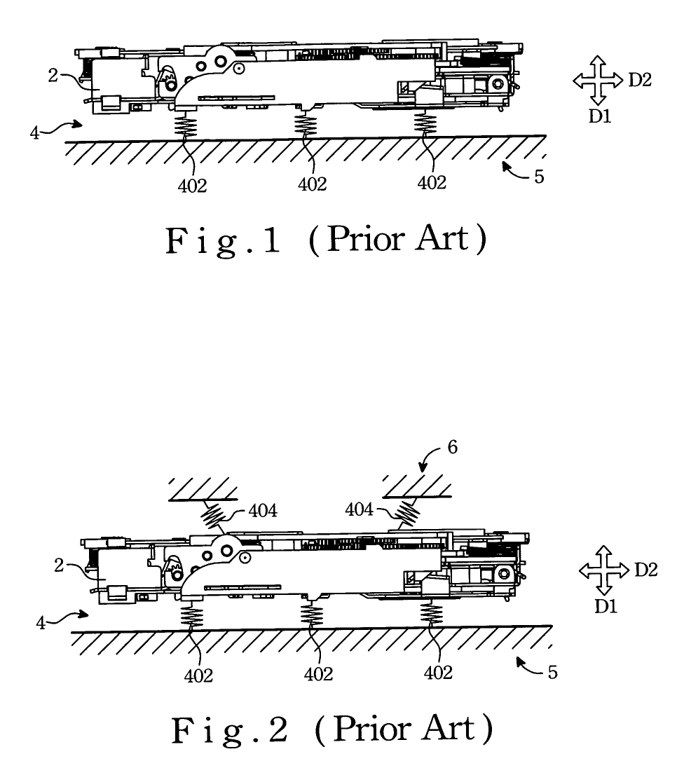

### DETAILED DESCCRIPTIONS OF THE PREFERRED EMBODIMENT

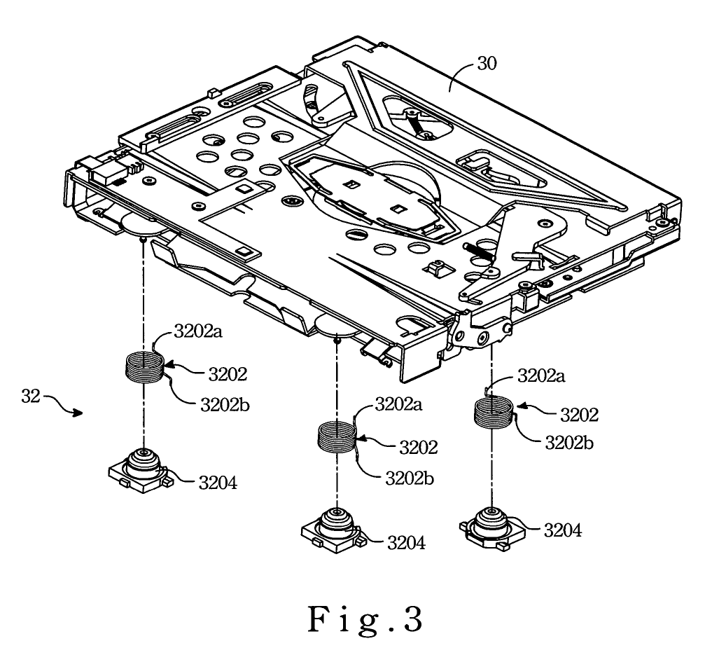

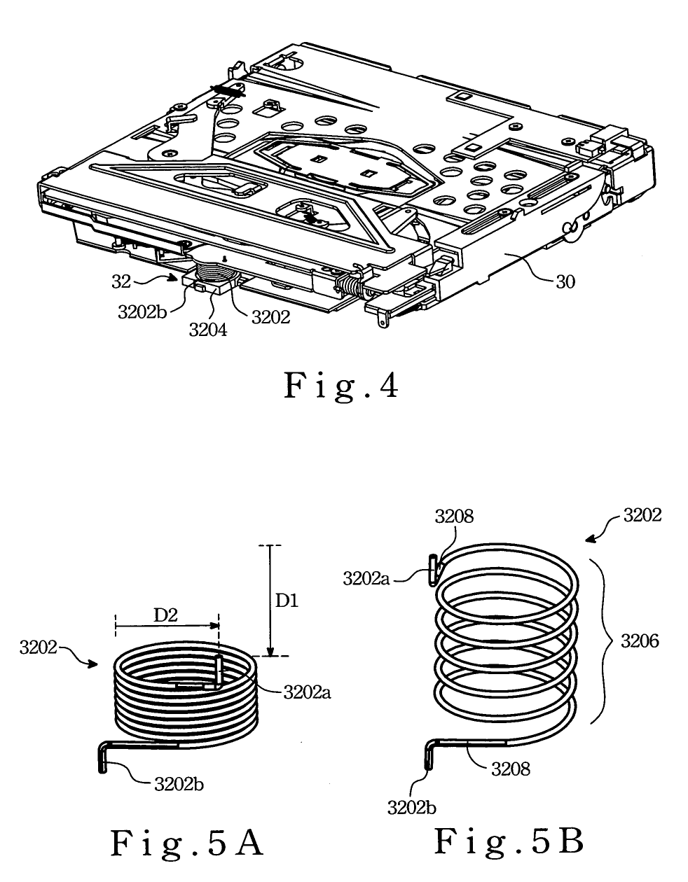

Referring to FIGS. 3 to 5, the preferred embodiment of a recording and reproducing apparatus of the present invention is shown. The recording and reproducing apparatus includes an outer casing (not visible since removed), a chassis 30, and a shock-absorbing system 32. The recording and reproducing apparatus is sometimes simply called a disk drive.

The chassis 30 is disposed within the outer casing for holding a plurality of electronic elements thereon, such as circuit chips, a pick-up head and so on. The shock-absorbing system 32 includes three dampers 3204 and three shock-absorbing members 3202. The dampers 3204 are mounted on the base member defined by a lower portion of the outer casing in a triangular configuration to provide maximum stability and balance thereof. Each of the shock-absorbing members 3202 has a main body 3206 and two extended portion 3208. The main body 3206 has a shape like a coil spring and defines a tension direction. The extended portions 3208 extend along the tension direction from two sides of the main body 3206. In this preferred embodiment, a torsion spring having a pitch is used as the shock-absorbing member. Therefore, the shock-absorbing member 3202 can absorb not only vertical impact but also horizontal impact. The shock-absorbing member 3202 further has an upper vertical portion 3202a that is fastened to the chassis 30 and a lower vertical portion 3202b that is fastened to the base member of the outer casing or embedded within a respective damper 3204 for increasing the impact absorbing effect, thereby supporting the chassis 30 above the outer casing. Both of the upper vertical portion 3202a and the lower vertical portion 3202b are vertically extended form the ends of the extended portions 3208 respectively.

Once the torsion springs having a pitch are thus arranged, the external impact applied on the recording and reproducing apparatus of the present invention in the D1 direction (vertical direction) is absorbed by virtue of compression of the torsion spring having a pitch in FIG. 5A to FIG. 5B. The external impact can be caused when the automobile provided with the present recording and reproducing apparatus runs over an uneven road surface. Alternatively, each of the torsion springs has lower and upper vertical portions which are fastened respectively to the base member of the outer casing and the chassis 30 so as to provide the same effects. When the external impact is applied onto the recording and reproducing apparatus of the present invention in the D2 direction (the horizontal direction), the impact will be absorbed by the torsion springs due to their turnings between the upper and lower vertical portions thereof. Thus, the data recording and reproducing effect thereof is undisturbed once the apparatus is provided with the shock-absorbing members 3202 having the unique structure. The diameter and the pitch of the torsion spring and the material for constructing the torsion spring can be adjusted to provide an appropriate restoration force in order to achieve the maximum shock-absorbing effect.

As to the structure of the pick-up head and how the latter is mounted on the chassis 30 for reading the disk are not the relevant feature of the present invention, a detailed disclosure thereof is omitted herein for the sake of brevity.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A recording and reproducing apparatus comprising:
an outer casing defining a base member;
a chassis disposed above said base member for holding a plurality of electronic elements thereon; and
a shock-absorbing member disposed between said base member and said chassis, and having a main body and two extended portion,
wherein, said main body has a shape like a coil spring and defines a tension direction,
wherein, said extended portions extend along said tension direction from two opposite sides of said main body respectively.

2. The recording and reproducing apparatus according to claim 1, wherein said shock-absorbing member further has a lower vertical portion and an upper vertical portion, wherein said lower vertical portion is mounted on said base member and said upper vertical portion is fastened to said chassis.

3. The recording and reproducing apparatus according to claim 2, wherein said lower vertical portion and said upper vertical portion are vertically extended from said two extended portions respectively.

4. The recording and reproducing apparatus according to claim 1, wherein said shock-absorbing member is a torsion spring having a pitch.

5. The recording and reproducing apparatus according to claim 1, wherein said apparatus is an optical disk drive.

6. The recording and reproducing apparatus according to claim 1 further comprising a damper mounted on said base member, said shock-absorbing member being disposed on said damper.

7. The recording and reproducing apparatus according to claim 1, further comprising at least three dampers mounted on said base member in a triangular configuration, said shock-absorbing member including three torsion springs, said lower end of each of said torsion springs being embedded in a respective one of said pedestals.
